(19) United States
(12) Patent Application Publication
(10) Pub. No.: US 2009/0038869 A1
(43) Pub. Date: Feb. 12, 2009

(54) Endless Track Vehicle With Light Weight Drive Train Having A Sprocket And Chain Reduction

(76) Inventor: Mark Beyer, Waterford, MI (US)

Correspondence Address: DICKINSON WRIGHT PLLC, 38525 WOODWARD AVENUE, SUITE 2000, BLOOMFIELD HILLS, MI, 48304-2970, US

(21) Appl. No.: 12/121,186

(22) Filed: May 15, 2008

Related U.S. Application Data
(60) Provisional application No. 60/954,208, filed on Aug. 6, 2007.

(51) Int. Cl. B62M 27/02

(52) U.S. Cl. 180/190

(57) ABSTRACT

Disclosed is a snowmobile with a drive train arrangement that saves weight by eliminating the jack shaft and retains a chain drive final reduction while maintaining a balanced weight distribution. A sprocket and chain final reduction and the continuously variable transmission are disposed together on a common side of the frame. The sprocket and chain final reduction is disposed inboard of the continuously variable transmission. The sprocket and chain final reduction is disposed forward or rearward of the engine.

### CROSS REFERENCE TO RELATED APPLICATION

This application claims the benefit of U.S. Provisional Application No. 60/954,208, filed Aug. 6, 2007, which is incorporated by reference herein, in its entirety, for all purposes.

### TECHNICAL FIELD

This invention relates generally to a chain case in a drive train and, more particularly, to a chain case in a drive train of an endless track vehicle.

### BACKGROUND INFORMATION

Snowmobiles are motorized sleds that have skis in front for directional control and an endless belt drive in the rear for propulsion. These machines are useful for work and recreation and are commonly used in parts of the world that regularly experience substantial snow fall. They have been around for many years.

There has long been a need to reduce the weight of snowmobiles. The less a snowmobile weighs the greater its ability to accelerate quickly and the easier it is to maneuver. Conventional snowmobile construction uses a chain and sprocket drive train that require the use of three axes. Specifically, the conventional chain and sprocket drive trains include an engine drive shaft, a continuously variable transmission (CVT) extending from the engine drive shaft to a second shaft (known in the art as a ‘jack shaft’) and a chain and sprocket gear reduction from the second shaft to a third shaft. The third shaft includes sprockets for driving the continuous track that drives the snowmobile forward in the snow. For additional details of such structure, refer to U.S. Pat. Nos. 3,985,192, 5,685,387, and 6860826.

Each shaft and its corresponding parts (support brackets, bearings, etc.) add weight to the drive train. It is desirable to reduce the number of parts to reduce the weight of the snowmobile. As a further incentive to reduce the number of shafts used in a snowmobile, it is noted that moving parts, such as rotating shafts, tend to lower the energy efficiency of a drive train. Each moving part has some inherent inertia that requires energy to be moved, and each moving part has some amount of friction that requires energy to overcome.

A longstanding need in the snowmobile art also exists for a drive train that reduces shaft wind-up. Shaft wind-up is the term applied to the lag in torque across the length of a member. Shaft wind-up in snowmobiles can be reduced by eliminating a shaft in the drive train.

Thus, what is needed is a snowmobile drive train that reduces weight, inertia, and shaft wind-up by eliminating the need for a shaft.

It has been proposed to eliminate the jack shaft from a snowmobile drive train by using a chain drive mounted on the same side of the sled as the CVT. For additional details, refer to U.S. Pat. No. 3,521,718. While successful in eliminating the jack shaft, this proposed structure has some disadvantages of its own. Weight distribution side-to-side is very lopsided when both a CVT and a conventional chain case are arranged as shown in the '718 patent. Additionally, weight distribution front-to-back becomes front-heavy when the engine, CVT, and the conventional chain case are arranged together as shown in the '718 patent. It also raises the center of gravity of the snowmobile. Such front-heavy, top-heavy, and lopsided weight distribution has an adverse affect on handling of a snowmobile, making the sled more difficult to control. This is a safety issue for novice riders and a competitive disadvantage to racers.

Thus, what is needed is a way to improve mechanical efficiency of a snowmobile drive train without compromising handling characteristics of the snowmobile.

It has been proposed to eliminate the jack shaft from a snowmobile drive train by using a multiple gear reduction to link the CVT to the shaft carrying the sprockets for driving the continuous track. For additional details, refer to U.S. Pat. Nos. 6,755,271, 6,907,951, and 7,104,353. While successful in eliminating the jack shaft, this proposed structure has some disadvantages of its own. A geared transmission is relatively heavy, particularly if a reverse shift is included, or if a planetary gearing scheme is used. A transmission with numerous gears wastes energy as a result of friction between the gears, particularly in planetary transmissions. The use of a geared transmission also drastically limits choices for swapping in different gears to achieve varied reduction ratios in the final drive. This limits flexibility not only at the factory, but also for after market modification of the snowmobile. The freedom to make such modifications is particularly important to those who race snowmobiles competitively.

Thus, what is needed is a way to eliminate a shaft from the conventional snowmobile drive train while improving mechanical efficiency of a snowmobile drive train without compromising the ability to vary final drive reduction ratios to suit varied situations.

### SUMMARY OF THE INVENTION

In general terms, this invention provides a snowmobile that is lighter and more efficient. The advantages for the snowmobile are accrued by use of a drive train arrangement that saves weight by eliminating the jack shaft and retaining a chain drive final reduction while maintaining a balanced weight distribution with a low center of gravity.

A snowmobile embodying aspects of the present invention has a frame supported at a forward part by a pair of skis and supported at a rearward part by an endless track, with an engine fastened to the frame. The snowmobile has a CVT that provides smooth transition of drive ratios from the engine to a final drive. The snowmobile's CVT has a primary clutch and a secondary clutch, the primary clutch being connected to be driven by the engine and the secondary clutch being connected to be driven by the primary clutch with an endless belt. The snowmobile also has a final reduction, which has a housing fastened to the frame. The housing encloses a primary sprocket, a secondary sprocket, and a chain. The primary sprocket is connected to be driven by the secondary clutch of the CVT via an input shaft, and the secondary sprocket is connected to be driven by the primary sprocket via the chain. The secondary sprocket is connected to drive the endless track via an output shaft. The CVT and the final reduction are disposed together on a common side of the frame. The final reduction is disposed inboard of the CVT. The final reduction is disposed forward or rearward of the engine. The snowmobile is free of a jack shaft.

A drive reduction embodying aspects of the present invention provides rotational energy to an endless track drive shaft of a snowmobile. The drive reduction has a housing with lugs for fastening the housing to a frame of the snowmobile. The housing is sized to be sandwiched between a clutch of the snowmobile and the frame. The drive reduction has a primary sprocket disposed inside the housing and an input shaft integral with the primary sprocket and engageable with the clutch to transfer rotational energy from the clutch to the primary sprocket. The drive reduction further has a secondary sprocket disposed inside the housing, and a chain disposed inside the housing and engaged to the primary sprocket and the secondary sprocket so as to transfer rotational energy from the primary sprocket to the secondary sprocket. The drive reduction also has an output shaft integral with the secondary sprocket and engageable with the endless track drive shaft to transfer rotational energy from the secondary sprocket to the endless track.

These and other features and advantages of this invention will become more apparent to those skilled in the art from the detailed description of a preferred embodiment. The drawings that accompany the detailed description are described below.

### BRIEF DESCRIPTION OF THE DRAWINGS

FIG. 1 illustrates an elevation view of a snowmobile according to an embodiment of the present invention, with the drive train indicated by broken lines.

FIG. 2 illustrates a perspective view of a snowmobile drive train according to an embodiment of the present invention.

FIG. 3 illustrates a partial section plan view of the snowmobile drive train of FIG. 2 integrated with a snowmobile frame.

FIG. 4 illustrates a perspective view of a sprocket and chain final reduction for use in a drive train according to embodiments of the present invention.

FIG. 5 illustrates a sectioned elevation view of the sprocket and chain final reduction of FIG. 4, with an example combination of sprockets.

### DETAILED DESCRIPTION

Arranging the drive train according to the present invention has a number of benefits for performance of a snowmobile. By saving weight, the snowmobile can accelerate faster. Weight is saved by eliminating the Jack shaft that has conventionally stretched across the entire width of the snowmobile. Weight is also saved by avoiding a geared transmission in favor of a sprocket and chain final reduction.

Good balance of the snowmobile is achieved, both front-to-rear and side-to-side weight distribution being nominally even so as to provide good handling performance for the snowmobile. The use of a sprocket and chain final reduction allows for flexible implementation of final drive ratios by simply swapping out a sprocket. Using a chain drive wastes less energy than a geared transmission because the chain has less friction between its parts. Manufacturing cost is also improved.

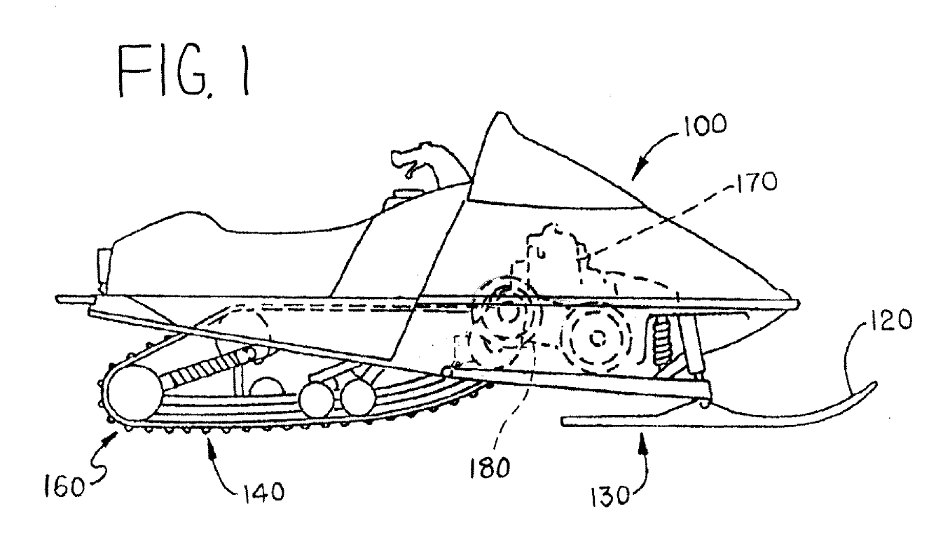

Referring to FIG. 1, a snowmobile according to an embodiment of the present invention is shown in an elevation view, with the drive train indicated by broken lines. The snowmobile 100 includes a pair of skis 120 that support the forward portion 130 of the snowmobile 100. A continuous track 140 supports the rear portion 160 of the snowmobile 100. The snowmobile 100 has an engine 170 that is disposed on the forward portion 130. The engine 170 rotatably drives a train 180 which in turns drives the endless track 140.

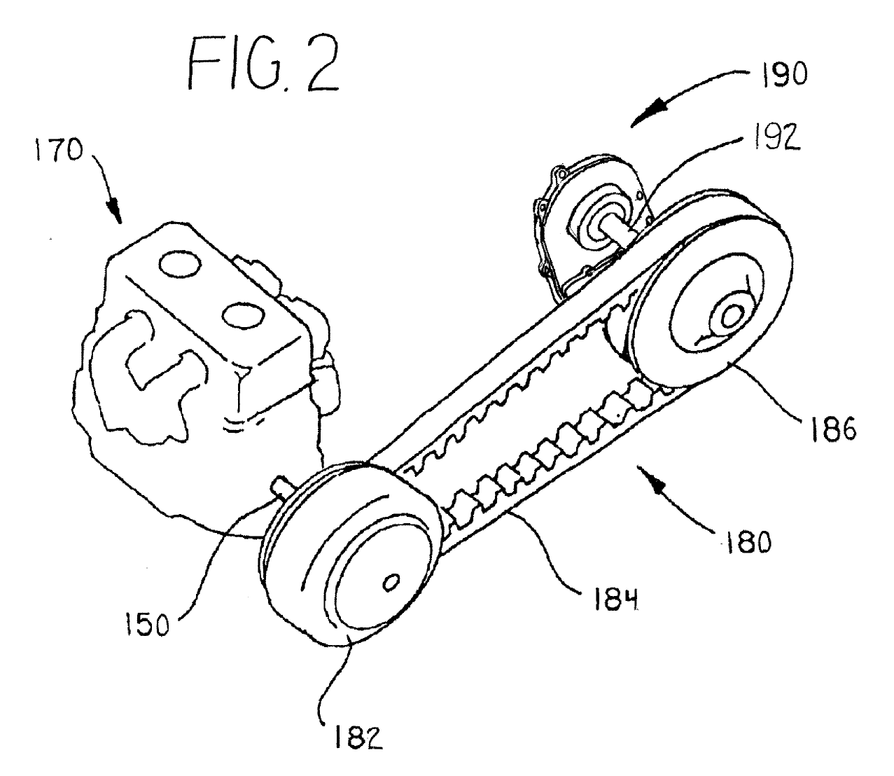

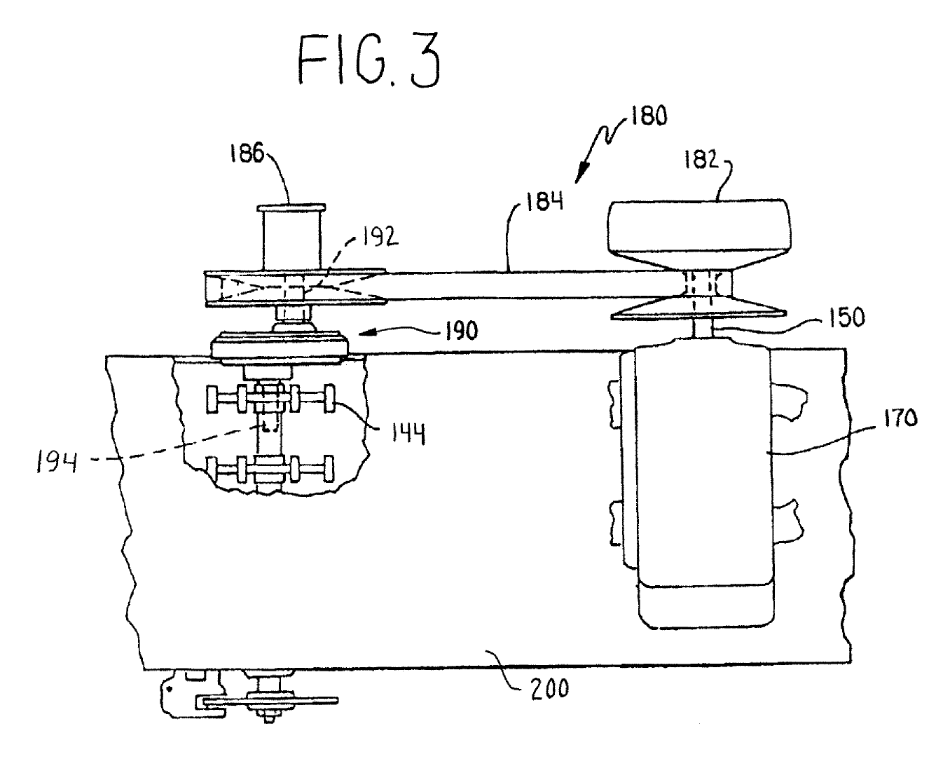

Referring to FIG. 2, a snowmobile drive train according to an embodiment of the present invention is shown in a perspective view. The drive train 180 includes an engine drive shaft 150, primary clutch 182, a drive belt 184, a secondary clutch 186 and a final reduction drive 190. Together the primary clutch 182, drive belt 184, and secondary clutch 186 function as a CVT. The reduction drive 190 has an input drive shaft 192 that is rotatably driven by the secondary clutch 186. The second shaft 194 (see FIG. 3) serves to drive the endless track 140 (see FIG. 1) through sprocket 144 (see FIG. 3).

Referring to FIG. 3, the snowmobile drive train of FIG. 2 is shown in a partial section plan view to indicate integration with a snowmobile frame. The drive train 180 includes an engine drive shaft 150, primary clutch 182, a drive belt 184, a secondary clutch 186 and a final reduction drive 190. The reduction drive 190 has an input drive shaft 192 that is rotatably driven by the secondary clutch 186. The output drive shaft 194 serves to drive the endless track 140 (see FIG. 1) through sprocket 144. The engine 170 and the final reduction drive 190 are both removably fastened to the frame 200.

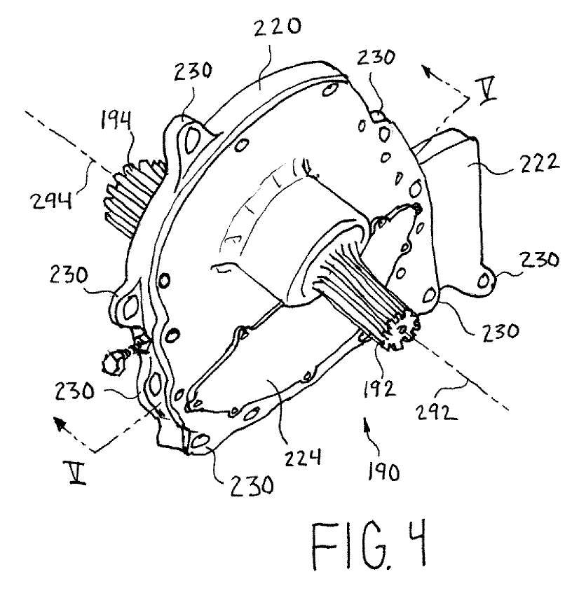

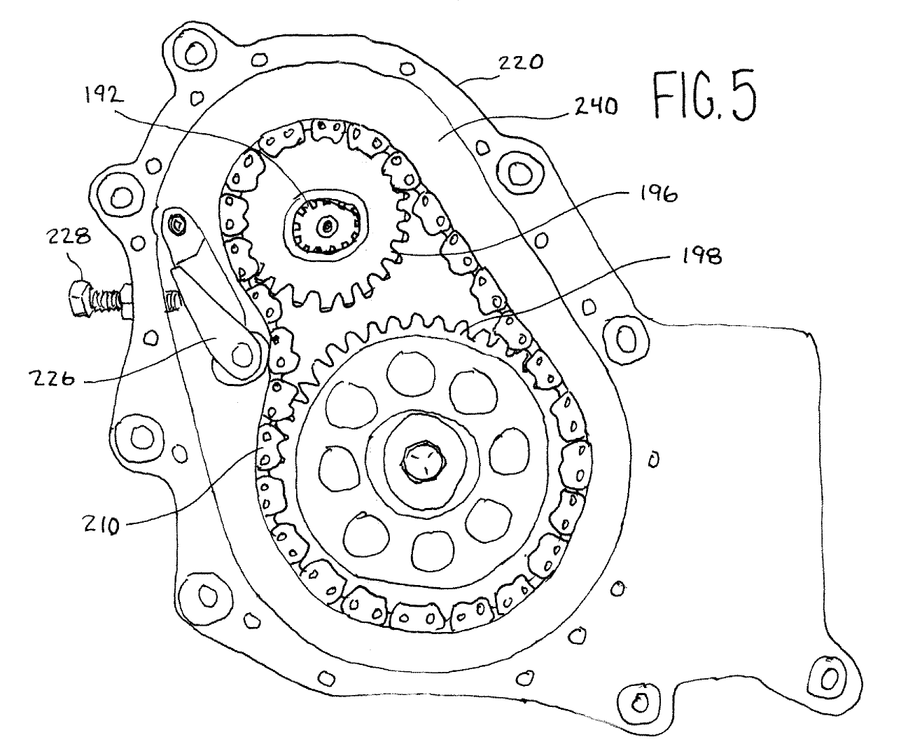

Referring to FIG. 4, a sprocket and chain final reduction 190 for use in a drive train is shown in perspective view. The input drive shaft 192 is rotationally connectable to the secondary clutch 186 of the CVT (see FIG. 3). A rotational mechanical advantage reduction is afforded by a pair of sprockets connected by a drive chain 210 (see FIG. 5), the driving sprocket 196 being mounted to the input drive shaft 192 and the driven sprocket 198 being mounted to the output drive shaft 194. The input and output drive shafts 192, 194 are not coaxial and have rotational axes 292, 294 that are parallel and slightly offset from one another. The housing 220 of the final reduction 190 is fixable to the frame 200 via a rear flange 222 and mounting lugs 230. A removable service cover 224 is provided on the housing 220 to enable inspection and maintenance of the drive chain 210.

Referring to FIG. 5, the sprocket and chain final reduction of FIG. 4 is shown in a sectioned elevation view (taken along section line V-V in FIG. 4) to provide an example of a combination of sprockets that may be implemented according to an embodiment of the present invention. The input drive shaft 192 carries a driving sprocket 196, which is integral with input drive shaft 192. The output drive shaft 194 (see FIG. 4) carries a driven sprocket 198, which is integral with output drive shaft 196. The input and output drive shafts 192, 194 are rotatably supported in the housing 220 using suitable bearings, such as roller bearings. The drive chain 210 engages both the driving sprocket 196 and the driven sprocket 198 and slack in the chain 210 is taken up by an adjustable tensioner 226. Position of the tensioner is selectably set by an adjustment bolt 228. The driving sprocket 196, the drive chain 210, driven sprocket 198, and the adjustable tensioner 226 are all disposed in a cavity 240 formed inside the housing 220.

One of the advantages of the disclosed drive train is that it provides flexibility for modifying the final drive ratio. There are few choices for varying the ratio of a geared transmission, but with a chain drive that is not the case. Sprockets of different tooth counts can be substituted for the primary and/or secondary sprockets 196, 198. Slack in the chain 210 can be taken up, to a point, using the adjustable tensioner 226. A different length chain 210 may be substituted, as needed.

The invention is not limited to use in snowmobiles and is applicable to other types of continuous track conveyance. The particular type of sprocket or chain illustrated is not critical to practice of the invention and other suitable types may be used.

A chain and sprocket final reduction according to embodiments of the present invention is useful as a substitute for the Diamond Direct Drive planetary gear reduction employed in models of the Arctic Cat© brand snowmobiles.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

What is claimed is:

1. A snowmobile comprising:
a frame supported at a forward part by a pair of skis and supported at a rearward part by an endless track;
an engine fastened to the frame;
a continuously variable transmission comprising a primary clutch and a secondary clutch, the primary clutch being connected to be driven by the engine and the secondary clutch being connected to be driven by the primary clutch;
a final reduction having a housing fastened to the frame, the housing containing a primary sprocket, a secondary sprocket, and a chain, the primary sprocket being connected to be driven by the secondary clutch, the secondary sprocket being connected to be driven by the primary sprocket via the chain, and the secondary sprocket being connected to drive the endless track;
wherein the continuously variable transmission and the final reduction are disposed together on a common side of the frame with the final reduction being disposed inboard of the continuously variable transmission, the snowmobile being free of a jack shaft.

2. The snowmobile according to claim 1, wherein the final reduction is disposed forward or rearward of the engine.

3. A snowmobile comprising:
a frame supported at a forward part by a pair of skis and supported at a rearward part by an endless track;
an engine fastened to the frame;
a continuously variable transmission comprising a primary clutch and a secondary clutch, the primary clutch being connected to be driven by the engine and the secondary clutch being connected to be driven by the primary clutch;
a final reduction having a housing fastened to the frame, the housing containing a primary sprocket, a secondary sprocket, and a chain, the primary sprocket being connected to be driven by the secondary clutch, the secondary sprocket being connected to be driven by the primary sprocket via the chain, and the secondary sprocket being connected to drive the endless track;
wherein the continuously variable transmission and the final reduction are disposed together on a common side of the frame with the final reduction being disposed forward or rearward of the engine, the snowmobile being free of a jack shaft.

4. A snowmobile comprising:
a frame supported at a forward part by a pair of skis and supported at a rearward part by an endless track;
an engine fastened to the frame;
a continuously variable transmission comprising a primary clutch and a secondary clutch, the primary clutch being connected to be driven by the engine and the secondary clutch being connected to be driven by the primary clutch;
a final reduction having a housing fastened to the frame, the housing containing a primary sprocket, a secondary sprocket, and a chain, the primary sprocket being connected to be driven by the secondary clutch, the secondary sprocket being connected to be driven by the primary sprocket via the chain, and the secondary sprocket being connected to drive the endless track;
wherein the final reduction is disposed forward or rearward of the engine and inboard of the continuously variable transmission, the snowmobile being free of a jack shaft.

5. A drive reduction for providing rotational energy to an endless track drive shaft of a snowmobile, the drive reduction comprising:
a housing having lugs for fastening the housing to a frame of the snowmobile, wherein the housing is sized to be sandwiched between a clutch of the snowmobile and the frame;
a primary sprocket disposed inside the housing;
an input shaft integral with the primary sprocket and adapted to engage the clutch to transfer rotational energy from the clutch to the primary sprocket;
a secondary sprocket disposed inside the housing; and
a chain disposed inside the housing and engaged to the primary sprocket and the secondary sprocket so as to transfer rotational energy from the primary sprocket to the secondary sprocket; and
an output shaft integral with the secondary sprocket and adapted to engage the endless track drive shaft to transfer rotational energy from the secondary sprocket to the endless track.
